(19) United States
(12) Patent Application Publication
(10) Pub. No.: US 2024/0386194 A1
(43) Pub. Date: Nov. 21, 2024

(54) METHOD, APPARATUS, DEVICE AND MEDIUM FOR PROCESSING COLLABORATIVE TABLE DATA

(71) Applicant: Beijing Zitiao Network Technology Co., Ltd., Beijing (CN)

(72) Inventor: Kailin XU, Beijing (CN)

(21) Appl. No.: 18/665,026

(22) Filed: May 15, 2024

(30) Foreign Application Priority Data
May 15, 2023 (CN) 202310544812.1

(51) Int. Cl. G06F 40/177; G06F 40/242; G06Q 10/101

(52) U.S. Cl. CPC G06F 40/177; G06F 40/242; G06Q 10/101

(57) ABSTRACT

The present disclosure discloses a method, an apparatus, a device and a medium for processing collaborative table data. The method includes: when a first client uses a collaborative table, acquiring a first data processing operation of a user on a first cell and a second cell in the collaborative table, wherein the second cell is one or more cells to be processed; generating first atomic operation information based on the first data processing operation, wherein the first atomic operation information includes a second cell and citation information; sending the second cell and the citation information to the second client, so that the second client updates the collaboration table according to the second cell and the citation information.

### CROSS-CITATION TO RELATED APPLICATIONS

This application claims the priority to and benefits of the China Patent Application, No. 202310544812.1, which was filed on May 16, 2023. The aforementioned patent application is hereby incorporated by citation in its entirety.

### TECHNICAL FIELD

The present disclosure relates to the technical field of computers, in particular to a method, a apparatus, a device and a medium for processing collaborative table data.

### BACKGROUND

In the collaborative office scenario, online collaborative table play an important role. Collaborative forms can support simultaneous online editing by multiple people. When a user edits the contents of a collaborative table, the edited contents can be displayed synchronously in other clients that open the collaborative form.

When users edit data in a collaborative table, an atomic operation for data changes of cells to be processed are generated, which describe all the cells to be processed, changed data and other information. Then, the atomic operation is sent to other clients that are opening the collaborative table for application, so as to realize the synchronous change of the collaborative table data.

In collaborative tables containing a large number of formulas, users usually copy and paste or pull-down some written formulas, so as to calculate the same type of formulas in batches later. At this time, the atomic operation will produce a lot of data to describe the formula filled in the cell, which will cause a large amount of data to be transmitted when other clients synchronize the collaborative table, and the efficiency of data transmission is relatively low, and the efficiency of other clients applying the atomic operation to synchronize data is also low.

### SUMMARY

In view of foregoing, the present disclosure provides a method, a apparatus, device and a medium for processing collaborative table data, so as to reduce the data amount of atomic operation, improve the efficiency of data transmission and the efficiency of synchronous atomic operation of other clients.

In a first aspect of the present disclosure, there is provided a method for processing collaborative table data, characterized in that wherein the method is applied to a first client, and the method comprises:
acquiring a first data processing operation of a user on a first cell and a second cell in a collaboration table, wherein the second cell is one or more cells to be processed;
generating first atomic operation information based on the first data processing operation, wherein the first atomic operation information comprises the second cell and citation information;
sending the second cell and the citation information to a second client, so that the second client updates the collaboration table according to the second cell and the citation information.

In a second aspect of the present disclosure, there is provided a method for processing collaborative table data, wherein the method is applied to a second client, and the method comprises:
receiving first atomic operation information sent by a first client, wherein the first atomic operation information is generated by the first client based on a first data processing operation of a user on a first cell and a second cell in a collaboration table, and the second cell is one or more cells to be processed, and the first atomic operation information comprises the second cell and citation information;
updating the collaboration table based on the second cell and the citation information.

In a third aspect of the present disclosure, there is provided an apparatus for processing collaborative table data, wherein the apparatus is applied to a first client, and the apparatus comprises:
an acquiring unit, configured for acquiring a first data processing operation of a user on a first cell and a second cell in a collaboration table, wherein the second cell is one or more cells to be processed;
a generating unit, configured for generating first atomic operation information based on the first data processing operation, wherein the first atomic operation information comprises the second cell and citation information;
a sending unit, configured for sending the second cell and the citation information to a second client, so that the second client updates the collaboration table according to the second cell and the citation information.

In a fourth aspect of the present disclosure, there is provided an apparatus for processing collaborative table data, wherein the apparatus is applied to a second client, and the apparatus comprises:
a receiving unit, configured for receiving first atomic operation information sent by a first client, wherein the first atomic operation information is generated by the first client based on a first data processing operation of a user on a first cell and a second cell in a collaboration table, and the second cell is one or more cells to be processed, and the first atomic operation information comprises the second cell and citation information;
an updating unit, configured for updating the collaboration table based on the second cell and the citation information.

In a fifth aspect of the present disclosure, there is provided an electronic device comprising: a processor and a memory;
the memory is configured for storing instructions or computer programs;
the processor is configured for executing the instructions or computer programs in the memory, so that the electronic device executes the method of the first aspect or the second aspect.

In a sixth aspect of the present disclosure, there is provided a computer-readable storage medium, wherein instructions are stored on the computer-readable storage medium, and when the instructions are executed on by a device, the device is caused to perform the method of the first aspect or the second aspect.

In a seventh aspect of the present disclosure, there is provided a computer program product, which comprises computer programs/instructions, which, when executed by a processor, implement the method of the first aspect or the second aspect.

Thus, the present disclosure has the following beneficial effects:

In the above implementation of the present disclosure, when the first client uses the collaboration table, the first data processing operation of the user on the first cell and the second cell in the collaboration table can be acquired, and the second cell is one or more cells to be processed, for example, the contents of the first cell are copied and pasted into the second cell. Then, first atomic operation information is generated based on the first data processing operation, wherein the first atomic operation information includes a second cell and citation information. The second cell and the citation information are sent to the second client, so that the second client can update the collaboration table according to the second cell and the citation information. By the method provided by the present disclosure, the cited atomic operation information can be generated, the data amount in the atomic operation information can be reduced, the data transmission efficiency can be improved, and at the same time, the efficiency of updating the collaborative table by using the atomic operation information by other clients can be improved.

### BRIEF DESCRIPTION OF DRAWINGS

In order to clearly illustrate the technical solution of the embodiment of the present disclosure or the prior art, the drawings of the embodiments or the prior art will be briefly described in the following; it is obvious that the described drawings are only related to some embodiments of the present disclosure. For an ordinary skilled in the art, other drawings can be obtained according to these drawings without creative work.

FIG. 1 is a flowchart of a method for processing collaborative table data provided by an embodiment of the present disclosure;

FIG. 2 is a flowchart of another method for processing collaborative table data provided by an embodiment of the present disclosure;

FIG. 3 is a flowchart of a method for updating a collaboration table provided by an embodiment of the present disclosure;

FIG. 4 is a schematic diagram of an apparatus for processing collaborative table data provided by an embodiment of the present disclosure;

FIG. 5 is a schematic diagram of another apparatus for processing collaborative table data provided by an embodiment of the present disclosure;

FIG. 6 is a schematic structural diagram of an electronic device provided by an embodiment of the present disclosure.

### DETAILED DESCRIPTION

In order to make people in the technical field better understand the solution of the present disclosure, the technical solutions in the embodiment of the present disclosure will be described clearly and completely with the attached drawings. Obviously, the described embodiment is only a part of the embodiment of the present disclosure, but not all the embodiments. Based on the embodiments in the disclosure, all other embodiments obtained by an ordinary skilled in this field without creative work belong to the protection scope of the present disclosure.

In collaborative tables containing a large number of formulas, users usually copy and paste or pull-down some written formulas, so as to calculate the same type of formulas in batches later. At this time, atomic operation will generate a lot of data to describe the formula filled in the cell, which will cause a large amount of data to be transmitted when other clients synchronize the collaborative table, and the efficiency of data transmission is relatively low, and the efficiency of other clients applying atomic operation to synchronize data is also low.

Based on this, the embodiment of the present disclosure provides a method for processing collaborative table data, so as to reduce the data amount of atomic operation, improve the efficiency of data transmission and the efficiency of synchronous atomic operation of other clients. For example, when the first client uses the collaboration table, the first client can acquire the first data processing operation of the user on the first cell and the second cell in the collaboration table, and the second cell is one or more cells to be processed. For example, the contents of the first cell is copied and then pasted into the second cell. A first client may generate first atomic operation information based on a first data processing operation, wherein the first atomic operation information includes a second cell and citation information. The second cell and the citation information are sent to the second client, so that the second client updates the collaboration table according to the second cell and the citation information. By the method provided by the present disclosure, the cited atomic operation information can be generated, the data amount in the atomic operation information can be reduced, the data transmission efficiency can be improved, and at the same time, the efficiency of updating the collaborative table by using the atomic operation information by other clients can be improved.

In order to facilitate the understanding of the technical solution provided by the embodiment of present disclosure, the following will be introduced in detail with the attached drawings.

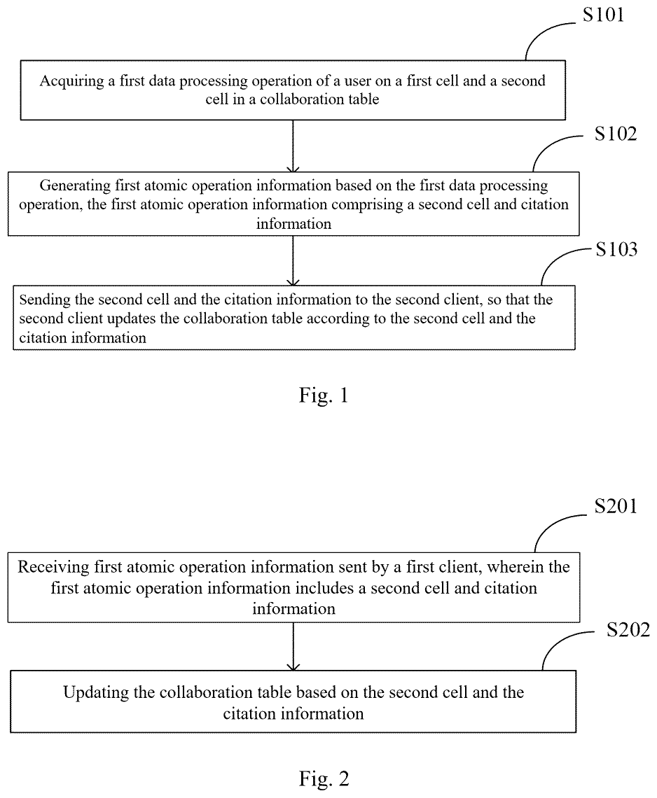

Referring to FIG. 1, FIG. 1 is a flowchart of a method for processing collaborative table data provided by an embodiment of the present disclosure.

The method can be applied to a first client, and the first client can be a terminal apparatus, such as a mobile apparatus, a server and the like. A collaboration table is applied in the first client, and the collaboration table can be applied to a plurality of clients, for example, the collaboration table can also be applied to a second client, which can be one or more clients different from the first client.

The method may include the following steps:

S101: acquiring a first data processing operation of a user on a first cell and a second cell in a collaboration table.

Because the collaboration table is applied to the first client, the user can operate the collaboration table in the first client. When the user performs the first data processing operation on the first cell and the second cell in the collaboration table, the first client can acquire the first data processing operation. The first cell contains a formula, that is, the first data processing operation is a operation for processing the formula. The second cell is one or more cells to be processed. The first data processing operation is to copy the contents of the first cell and paste it into the second cell, or to fill the second cell based on the contents of the first cell. For example, a second cell is filled by a pull-down based on the first cell.

S102: generating first atomic operation information based on the first data processing operation, the first atomic operation information comprising a second cell and citation information.

The first client can generate the first atomic operation information after acquiring the first data processing operation of the user, and the first atomic operation information includes the second cell to be processed and the citation information. That is, the first atomic operation information can be used to describe the user's first data processing operation, so that the subsequent second client can update the collaboration table according to the first atomic operation information and realize the synchronization of the collaboration table content. Alternatively, the format of the atomic operation can be preset by the first client, so that the first atomic operation information corresponding to the first data processing operation can be generated based on the preset format.

In one exemplary implementation, the citation information may include a citation identifier and a citation content, and the citation identifier can be used to distinguish different citation contents, that is, the citation identifier and the citation content are in one-to-one correspondence. Atomic operation information can be generated based on the citation identifier in citation information and citation information, which can reduce the amount of data in atomic operation information and improve the efficiency of data transmission. When the user's data processing operations are of the same type, the same citation information can be directly called to generate atomic operation information, which saves the process of generating atomic operation information and improves data processing efficiency.

In one exemplary implementation, because the citation information is generated based on the operation of the cell, the citation content includes the information of the cell. Other information generated according to data processing operations can also be included in the citation content, which is not repeated here. Optionally, the citation content may include cell citation information. Among them, the description of cell is mainly divided into two formats, including A1 citation style and R1C1 citation style. The citation style of A1 refers to the citation of the letter sign column and number sign row. For example, B25 refers to the cell at the intersection of column B and row 25. In the R1C1 citation style, R plus row number and C plus column number are used to indicate the position of cells. R1C1 citation style can also be divided into absolute citation and relative citation. Absolute citation refers to the citation according to the absolute position of the cell in the collaborative table. For example, R2C3 refers to the cell C2 at the second row and the third column in the collaborative table. Relative citation refers to describing the position of the cell based on the offset of the cell where the formula is located (in this embodiment, it refers to the first cell). When the offset is positive, it means downward or right offset; when the offset is negative, it means upward or left offset. For example, R[−1]C[−1] indicates that the position of the cited cell is based on the current cell moving up one row and moving left one column.

In this embodiment, in order to describe the citation information uniformly and reduce the amount of data in the atomic operation information, RIC1 citation style is adopted to represent cell citations. That is, both the first cell and the second cell are represented by R1C1 style, so that the relative position information can be determined based on R1C1 citation style corresponding to the first cell and R1C1 citation style corresponding to the second cell and then used as cell citation information that can be cited later.

Optionally, in order to facilitate the storage of the citation information and subsequent citations, the citation information is stored in a dictionary format; the citation identifier is the keyword of the dictionary and the citation content is the value of the dictionary.

In order to facilitate the understanding of the process of generating atomic operation information, a specific application scenario will be introduced below.

As shown in Table 1, the first row of the table is column A and column B, the first column is the row title, including the first row, the second row, the third row and the fourth row, and the formula “=A1+1” is included in the B1 cell. When the user pulls down to fill the cells B2, B3 and B4 based on the B1 cell, the theoretical results are B2=B1+1, B3=B2+1 and B4=B3+1. The contents of B2, B3 and B4 can all be represented as R[−1]C+1, that is, B2=R[−1]C+1, B3=R[−1]C+1, and B4=R[−1]C+1, so the same formula mentioned above can be stored as one citation information including the citation identifier and the corresponding citation content, the citation content is the same formula R[−1]C+1, and the citation identifier is used to distinguish different citation contents. The citation identifier can be represented by numbers or letters, and the embodiment does not limit this. For example, the citation information can be stored as the citation information with citation identifier of 1 and citation content of R[−1]C+1, that is, the citation information can be represented in the format shown in Table 2, and then the citation identifier can be stored at the position corresponding to the cell to be processed in the atomic operation information, as shown in Table 3, that is, the citation identifier 1 can be stored in cells B2, B3 and B4. When the second client subsequently applies the atomic operation information, the citation content corresponding to the citation identifier can be called according to the citation information in the dictionary format, restore the formula corresponding to the cell to be processed, and realize the synchronization of the collaborative table.

TABLE 1

| | A | B |
|---|---|---|
| 1 | 11 | =A1 + 1 |
| 2 | | |
| 3 | | |
| 4 | | |

TABLE 2

| Citation identifier | Citation content |
|---|---|
| 1 | R[−1]C + 1 |

TABLE 3

| Cell | Citation identifier |
|---|---|
| B2 | 1 |
| B3 | 1 |
| B4 | 1 |

S103: sending the second cell and the citation information to the second client, so that the second client updates the collaboration table according to the second cell and the citation information.

Because the atomic operation information includes the second cell to be processed and the citation information, the first client sends the atomic operation information to the second client, so that the second client updates the contents in the collaboration table according to the second cell and the citation information.

When the user subsequently performs the second data processing operation on the third cell and the fourth cell in the collaboration table, the third cell includes a formula and the fourth cell is one or more cells to be processed; when the second data processing operation is the same type as the first data processing operation, the second atomic operation information can be generated based on the fourth cell and the calling of the citation information generated by the first client. For example, when the first data processing operation is to pull-down based on the first cell so as to fill the second cell and the second data processing operation is to pull-down based on the third cell so as to fill the fourth cell, the citation information generated based on the first data processing operation is the same as that generated based on the second data processing operation. At this time, the first client can directly call the citation information and combine it with the position information of the fourth cell, so as to generate the second atomic operation information, thus saving the process of generating atomic operation information and improving the processing efficiency.

Subsequently, the first client can send the fourth cell and the citation information to the second client, so that the second client can update the collaboration table again according to the fourth cell and the citation information.

Based on the method in the above embodiment, the embodiment of the present disclosure further provides a method for processing data in the collaborative table. The following will be introduced with reference to the attached drawings.

Referring to FIG. 2, which is a flowchart of another method for processing collaborative table data provided by the embodiment of the present disclosure.

The method can be applied to a second client; the same collaboration table as the first client is applied in the second client, and the second client can be one or more clients different from the first client.

The method may include the following steps:

S201: receiving first atomic operation information sent by a first client, wherein the first atomic operation information includes a second cell and citation information.

The first atomic operation information is generated by the first client based on the user's first data processing operation on the first cell and the second cell in the collaboration table; the first cell includes a formula and the second cell is one or more cells to be processed, and the first atomic operation information includes the second cell and citation information. The specific steps for the first client to generate the first atomic operation information can be found in the above method embodiment, and will not be described here.

S202: updating the collaboration table based on the second cell and the citation information.

When the second client receives the second cell and the citation information sent by the first client, it can update the collaboration table according to the second cell and the citation information. Because the amount of data in the first atomic operation information is less, the efficiency of updating the collaborative table by the second client using atomic operation information can be improved.

In one exemplary implementation, the second client can update the collaboration table in the following ways, and the second client can deserialize the received citation information to acquire the deserialization result. That is, the citation information generated by the first client is restored to the formula example. Then, the collaborative table is updated based on the second cell and the deserialization result. Taking the present disclosure scenario provided in the above embodiment as an example, if the citation information corresponding to the B2 cell in the first atomic operation information is that the citation identifier is 1 and the citation content is R[−1]C+1, then the second client can deserialize the citation information and restore the formula example to B2=B1+1 by combining with the B2 cell. In addition, the second client can store the deserialization result obtained by deserializing based on the citation information, which is convenient for subsequent deserialization of the same citation information and can be directly called, thus simplifying the deserialization process and improving the efficiency of updating the collaborative table by using atomic operation information.

When the user performs the second data processing operation on the third cell and the fourth cell in the collaborative table, the first client can generate the second atomic operation information based on the second data processing operation, and send the second atomic operation information to the second client, so as to realize the synchronous update of the collaborative table. When the second data processing operation and the first data processing operation are of the same type, the second atomic operation information and the first atomic operation information have the same the citation information. Since the second client has deserialized the citation information, the stored deserialization result can be directly called when the received citation information is the same, thus simplifying the deserialization process and improving the efficiency of updating the collaboration table by the second client.

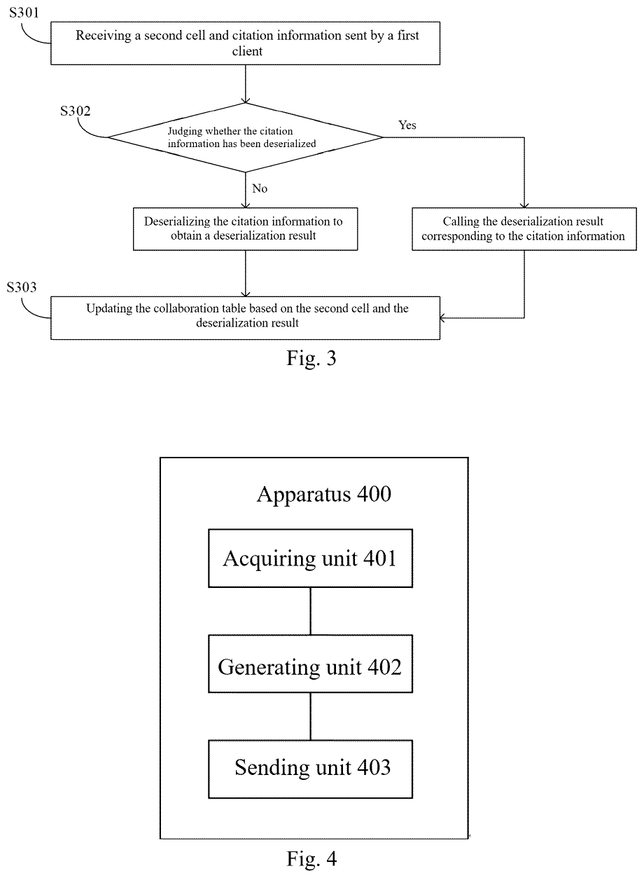

Based on this, the embodiment of the present disclosure provides a method for updating the collaboration table. Referring to FIG. 3, which is a flowchart of a method for updating a collaboration table provided by an embodiment of the present disclosure.

The method can be applied to a second client, and the method includes the following steps:

S301: receiving a second cell and the citation information sent by the first client;

S302: judging whether the citation information has been deserialized, if so, calling the deserialization result corresponding to the citation information; otherwise, deserializing the citation information to obtain a deserialization result;

S303: updating the collaboration table based on the second cell and the deserialization result.

The specific implementation of the embodiment of the present disclosure can refer to the above-mentioned embodiment, and will not be described here.

Based on the above method embodiment, the embodiment of the present disclosure further provides an apparatus for processing collaborative table data. Referring to FIG. 4, FIG. 4 is a schematic diagram of an apparatus for processing collaborative table data provided by an embodiment of the present disclosure.

The apparatus 400 can be applied to a first client, and the apparatus 400 includes:

An acquiring unit 401, configured to acquire a first data processing operation of a user on a first cell and a second cell in a collaboration table, wherein the second cell is one or more cells to be processed;

A generating unit 402, configured to generate first atomic operation information based on the first data processing operation, wherein the first atomic operation information includes the second cell and citation information;

A sending unit 403, configured to send the second cell and the citation information to a second client, so that the second client updates the collaboration table according to the second cell and the citation information.

In one exemplary implementation, the citation information includes a citation identifier and a citation content, and the citation identifier and the citation content are in one-to-one correspondence.

In one exemplary implementation, the citation information is a dictionary, the citation identifier is a keyword of the dictionary, and the citation content is a value of the dictionary.

In one exemplary implementation, the citation content includes cell citation information.

In one exemplary implementation, the first cell and the second cell are represented by R1C1 citation styles, and the cell citation information is determined based on a relative position information between R1C1 citation style corresponding to the first cell and R1C1 citation style corresponding to the second cell.

In one exemplary implementation, the first processing operation includes: copying and pasting content of the first cell into the second cell, or filling the second cell based on the contents of the first cell.

In one exemplary implementation, the acquiring unit 401 is further configured to acquire a second data processing operation of a user on a third cell and a fourth cell in the collaboration table, wherein the fourth cell is one or more cells to be processed;

The generating unit 402 is further configured to generate, when the first data processing operation and the second data processing operation are the same type of processing operations, second atomic operation information based on the fourth cell and calling the citation information;

The sending unit 403 is further configured to send the fourth cell and the citation information to the second client, so that the second client updates the collaboration table according to the fourth cell and the citation information.

The beneficial effects of the apparatus for processing the collaborative table data provided by the embodiment of the present disclosure can be found in the above method embodiment, and will not be repeated here.

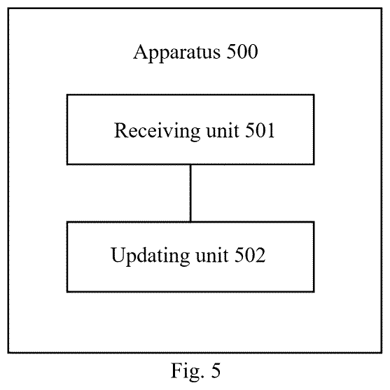

Based on the above method embodiment and apparatus embodiment, the embodiment of the present disclosure further provides an apparatus for processing collaborative table data. Referring to FIG. 5, FIG. 5 is a schematic diagram of another apparatus for processing collaborative table data provided by an embodiment of the present disclosure.

The apparatus 500 can be applied to a second client, and the apparatus 500 includes:

A receiving unit 501, configured to receive first atomic operation information sent by a first client; the first atomic operation information is generated by the first client based on a first data processing operation of a user on a first cell and a second cell in a collaboration table, and the second cell is one or more cells to be processed, and the first atomic operation information includes the second cell and citation information;

An updating unit 502, configured to update the collaboration table based on the second cell and the citation information.

In one exemplary implementation, the updating unit 502 is specifically configured to deserialize the citation information to acquire a deserialization result, and update the collaboration table based on the second cell and the deserialization result.

In a exemplary implementation, the receiving unit 501 is further configured to receive the second atomic operation information sent by the first client, which is generated by the first client based on the user's second data processing operation on the third cell and the fourth cell in the collaboration table; the first data processing operation is the same type as the second data processing operation, the fourth cell is one or more cells to be processed, and the second atomic operation information comprises the fourth cell and the citation information.

The updating unit 502 is further configured to update the collaboration table based on the fourth cell and call the deserialization result.

The beneficial effects of the apparatus for processing the collaborative table data provided by the embodiment of the present disclosure can be found in the above method embodiment, and will not be repeated here.

It should be noted that the specific implementation of each unit in this embodiment can refer to the relevant description in the above method embodiment. The division of units in the embodiment of the present disclosure is schematic, only a logical function division, and there may be another division method in actual implementation. Each functional unit in the embodiment of the present disclosure can be integrated into one processing unit, or each unit can exist separately and physically, or two or more units can be integrated into one unit. For example, in the above embodiment, the processing unit and the sending unit may be the same unit or different units. The above integrated units can be realized in the form of hardware or software functional units.

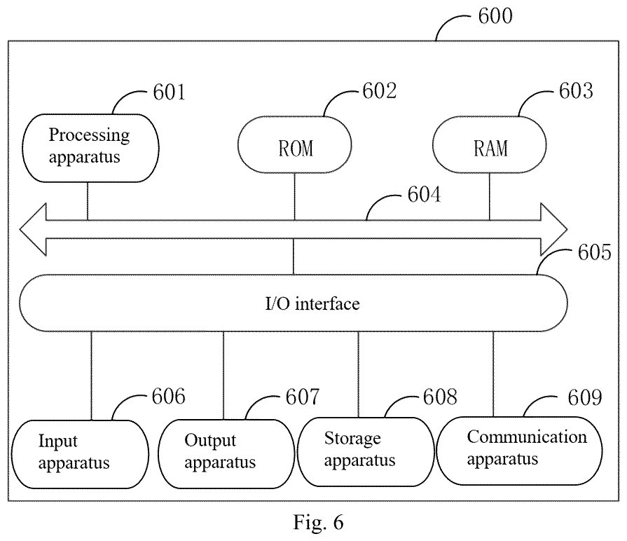

Referring to FIG. 6, FIG. 6 illustrates a schematic structural diagram of an electronic device 600 suitable for implementing the embodiments of the present disclosure. The terminal devices in embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 6 is merely an example, and should not pose any limitation to the functions and the range of use of the embodiments of the present disclosure.

As illustrated in FIG. 6, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 6 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

The electronic device provided by the embodiment of the present disclosure belongs to the same inventive concept as the method provided by the above embodiment, and the technical details not described in detail in this embodiment can be found in the above embodiment, and the present embodiment has the same beneficial effects as the above embodiment.

The embodiment of the present disclosure provides a computer storage medium, on which a computer program is stored, and when the program is executed by a processor, the method provided by the above embodiment is realized.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the above method.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, there is provided a method for processing collaborative table data, which is applied to a first client, and comprises:

Acquiring a first data processing operation of a user on a first cell and a second cell in a collaboration table, the second cell is one or more cells to be processed;

Generating first atomic operation information based on the first data processing operation, wherein the first atomic operation information comprises the second cell and citation information;

Sending the second cell and the citation information to a second client, so that the second client updates the collaboration table according to the second cell and the citation information.

According to one or more embodiments of the present disclosure, the citation information includes a citation identifier and a citation content, and the citation identifier is in one-to-one correspondence with the citation content.

According to one or more embodiments of the present disclosure, the citation information is a dictionary, the citation identifier is a keyword of the dictionary, and the citation content is a value of the dictionary.

According to one or more embodiments of the present disclosure, the citation content includes cell citation information.

According to one or more embodiments of the present disclosure, the first cell and the second cell are represented by R1C1 citation styles, and the cell citation information is determined based on the relative position information between a R1C1 citation style corresponding to the first cell and a R1C1 citation style corresponding to the second cell.

According to one or more embodiments of the present disclosure, the first processing operation includes: copying and pasting a content of the first cell into the second cell, or filling the second cell based on the content of the first cell.

According to one or more embodiments of the present disclosure, the method further comprises:

Acquiring a second data processing operation of a user on a third cell and a fourth cell in the collaboration table, the fourth cell is one or more cells to be processed;

In a case where the first data processing operation and the second data processing operation are the same type of processing operations, generating second atomic operation information based on the fourth cell and calling the citation information;

Sending the fourth cell and the citation information to the second client, so that the second client updates the collaboration table according to the fourth cell and the citation information.

According to one or more embodiments of the present disclosure, there is provided a method for processing collaborative table data, which is applied to a second client, and comprises:

Receiving first atomic operation information sent by a first client, wherein the first atomic operation information is generated by the first client based on a first data processing operation of a user on a first cell and a second cell in a collaboration table, and the second cell is one or more cells to be processed, and the first atomic operation information comprises the second cell and citation information;

Updating the collaboration table based on the second cell and the citation information.

According to one or more embodiments of the present disclosure, the updating of the collaboration table based on the second cell and the citation information comprises:

Deserializing the citation information to acquire a deserialization result;

Updating the collaboration table based on the second cell and the deserialization result.

According to one or more embodiments of the present disclosure, the method further comprises:

Receiving second atomic operation information sent by the first client, wherein the second atomic operation information is generated by the first client based on a second data processing operation of a user on a third cell and a fourth cell in the collaboration table, the first data processing operation is the same type as the second data processing operation, the fourth cell is one or more cells to be processed, and the second atomic operation information includes the fourth cell and the citation information;

Updating the collaboration table based on the fourth cell and a calling of the deserialization result.

According to one or more embodiments of the present disclosure, there is provided an apparatus for processing collaborative table data, which is applied to a first client, and comprises:

An acquiring unit, configured for acquiring a first data processing operation of a user on a first cell and a second cell in a collaboration table, wherein the second cell is one or more cells to be processed;

A generating unit, configured for generating first atomic operation information based on the first data processing operation, wherein the first atomic operation information comprises the second cell and citation information;

A sending unit, configured for sending the second cell and the citation information to a second client, so that the second client updates the collaboration table according to the second cell and the citation information.

In one or more embodiments of the present disclosure, the citation information includes a citation identifier and a citation content, and the citation identifier is in one-to-one correspondence to the citation content.

In one or more embodiments of the present disclosure, the citation information is a dictionary, the citation identifier is a keyword of the dictionary, and the citation content is a value of the dictionary.

In one or more embodiments of the present disclosure, the citation content includes cell citation information.

In one or more embodiments of the present disclosure, the first cell and the second cell are represented by R1C1 citation styles, and the cell citation information is determined based on relative position information between a R1C1 citation style corresponding to the first cell and a R1C1 citation style corresponding to the second cell.

In one or more embodiments of the present disclosure, the first processing operation includes: copying and pasting a content of the first cell into the second cell, or filling the second cell based on the content of the first cell.

In one or more embodiments of the present disclosure, the acquiring unit is further configured to acquire a second data processing operation of a user on a third cell and a fourth cell in the collaboration table, and the fourth cell is one or more cells to be processed;

The generating unit is further configured to generate, in a case where the first data processing operation and the second data processing operation are the same type of processing operations, second atomic operation information based on the fourth cell and calling the citation information;

The sending unit is further configured to send the fourth cell and the citation information to the second client, so that the second client updates the collaboration table according to the fourth cell and the citation information.

According to one or more embodiments of the present disclosure, there is provided an apparatus for processing collaborative table data, which is applied to a second client, and comprises:

A receiving unit, configured for receiving first atomic operation information sent by a first client, wherein the first atomic operation information is generated by the first client based on a first data processing operation of a user on a first cell and a second cell in a collaboration table, and the second cell is one or more cells to be processed, and the first atomic operation information includes the second cell and citation information;

An updating unit, configured for updating the collaboration table based on the second cell and the citation information.

In one or more embodiments of the present disclosure, the updating unit is specifically configured to deserialize the citation information to obtain a deserialization result; updating the collaboration table based on the second cell and the deserialization result.

In one or more embodiments of the present disclosure, the receiving unit is further configured to receive the second atomic operation information sent by the first client, which is generated by the first client based on the second data processing operation of the user on the third cell and the fourth cell in the collaboration table, wherein the first data processing operation is the same type as the second data processing operation, the fourth cell is one or more cells to be processed, and the second atomic operation information;

The updating unit is further configured to update the collaboration table based on the fourth cell and a calling of the deserialization result.

According to one or more embodiments of the present disclosure, there is provided an electronic device including a processor and a memory;

The memory is configured for storing instructions or computer programs;

The processor is configured for executing the instructions or computer programs in the memory, so that the electronic apparatus can execute the collaborative table data processing method.

According to one or more embodiments of the present disclosure, a computer-readable storage medium is provided, and instructions are stored in the computer-readable storage medium, which, when run on a apparatus, cause the apparatus to execute the processing method of the collaborative table data.

It should be noted that each embodiment in this specification is described in a progressive way, and each embodiment focuses on the differences from other embodiments, so the same and similar parts between the different embodiments may be referred to each other. As for the system or apparatus disclosed in the embodiment, because it corresponds to the method disclosed in the embodiment, the description is relatively simple, and the related part can be found in the description of the method part.

It should be understood that in this disclosure, “at least one (item)” means one or more, and “multiple” means two or more. “and/or” is used to describe the relationship of related objects, indicating that there can be three kinds of relationships. For example, “A and/or B” can indicate that there are only A, only B, or, both A and B, where A and B can be singular or plural. The character “/” generally indicates that the context object is an alternative relationship. “At least one of the following items (items)” or its similar expression refers to any combination of these items, including any combination of single items (items) or plural items (items). For example, at least one of a, b or c can be expressed as: a, b, c, a and b, a and c, b and c, or a and b and c, where a, b and c can be single or multiple.

It should also be noted that in this context, relational terms such as first and second are only used to distinguish one entity or operation from another entity or operation, and do not necessarily require or imply that there is any such actual relationship or order between these entities or operations. Moreover, the terms “including”, “including” or any other variation thereof are intended to cover non-exclusive inclusion, so that a process, method, article or device including a series of elements includes not only those elements, but also other elements not explicitly listed or elements inherent to such process, method, article or device. Without further restrictions, an element defined by the phrase “including one” does not exclude the existence of other identical elements in the process, method, article or device including the element.

The steps of a method or algorithm described in connection with the embodiments disclosed herein may be directly implemented in hardware, a software module executed by a processor, or a combination of the two. The software module can be placed in random access memory (RAM), internal memory, read-only memory (ROM), electrically programmable ROM, electrically erasable programmable ROM, register, hard disk, removable disk, CD-ROM, or any other storage medium known in the technical field.

The foregoing description of the disclosed embodiments enables those skilled in the art to make or use this disclosure. Many modifications to these embodiments will be obvious to those skilled in the art, and the general principles defined herein can be implemented in other embodiments without departing from the spirit or scope of this disclosure. Therefore, the present disclosure will not be limited to the embodiments shown herein, but has the widest scope consistent with the principles and novel features disclosed by this context.

1. A method for processing collaborative table data, wherein the method is applied to a first client, and the method comprises:
acquiring a first data processing operation of a user on a first cell and a second cell in a collaboration table, wherein the second cell is one or more cells to be processed;
generating first atomic operation information based on the first data processing operation, wherein the first atomic operation information comprises the second cell and citation information;
sending the second cell and the citation information to a second client, so that the second client updates the collaboration table according to the second cell and the citation information.

2. The method according to claim 1, wherein the citation information comprises a citation identifier and a citation content, and the citation identifier is in one-to-one correspondence with the citation content.

3. The method according to claim 2, wherein the citation information is a dictionary, the citation identifier is a keyword of the dictionary, and the citation content is a value of the dictionary.

4. The method according to claim 2, wherein the citation content comprises cell citation information.

5. The method according to claim 4, wherein the first cell and the second cell are represented by R1C1 citation styles, and the cell citation information is determined based on relative position information between a R1C1 citation style corresponding to the first cell and a R1C1 citation style corresponding to the second cell.

6. The method according to claim 1, wherein the first processing operation comprises:
copying a content of the first cell and pasting it into the second cell; or
filling the second cell based on the content of the first cell.

7. The method according to claim 1, wherein the method further comprises:
acquiring a second data processing operation of a user on a third cell and a fourth cell in the collaboration table, wherein the fourth cell is one or more cells to be processed;
in a case where the first data processing operation and the second data processing operation are same type of processing operations, generating second atomic operation information based on the fourth cell and a calling of the citation information;
sending the fourth cell and the citation information to the second client, so that the second client updates the collaboration table according to the fourth cell and the citation information.

8. A method for processing collaborative table data, wherein the method is applied to a second client, and the method comprises:
receiving first atomic operation information sent by a first client, wherein the first atomic operation information is generated by the first client based on a first data processing operation of a user on a first cell and a second cell in a collaboration table, and the second cell is one or more cells to be processed, and the first atomic operation information comprises the second cell and citation information;
updating the collaboration table based on the second cell and the citation information.

9. The method according to claim 8, wherein updating the collaboration table based on the second cell and the citation information comprises:
deserializing the citation information to acquire a deserialization result;
updating the collaboration table based on the second cell and the deserialization result.

10. The method according to claim 9, wherein the method further comprises:
receiving second atomic operation information sent by the first client, wherein the second atomic operation information is generated by the first client based on a second data processing operation of a user on a third cell and a fourth cell in the collaboration table, the first data processing operation is same type as the second data processing operation, the fourth cell is one or more cells to be processed, and the second atomic operation information comprises the fourth cell and the citation information;
updating the collaboration table based on the fourth cell and a calling of the deserialization result.

11. An electronic device, comprising: a processor and a memory;
the memory is configured for storing instructions or computer programs;
the processor is configured for executing the instructions or computer programs in the memory, so that the electronic apparatus executes the method according to claim 1.

12. An electronic device, comprising: a processor and a memory;
the memory is configured for storing instructions or computer programs;
the processor is configured for executing the instructions or computer programs in the memory, so that the electronic apparatus executes the method according to claim 8.

13. A computer-readable storage medium, wherein instructions are stored on the computer-readable storage medium, and when the instructions are executed by a device, the device is caused to perform the method according to claim 1.

14. A computer-readable storage medium, wherein instructions are stored on the computer-readable storage medium, and when the instructions are executed by a device, the device is caused to perform the method according to claim 8.

15. The method according to claim 2, wherein the first processing operation comprises:
copying a content of the first cell and pasting it into the second cell; or
filling the second cell based on the content of the first cell.

16. The method according to claim 3, wherein the first processing operation comprises:
copying a content of the first cell and pasting it into the second cell; or
filling the second cell based on the content of the first cell.

17. The method according to claim 4, wherein the first processing operation comprises:
copying a content of the first cell and pasting it into the second cell; or filling the second cell based on the content of the first cell.

18. The method according to claim 5, wherein the first processing operation comprises:
copying a content of the first cell and pasting it into the second cell; or
filling the second cell based on the content of the first cell.

19. The method according to claim 6, wherein the first processing operation comprises:
copying a content of the first cell and pasting it into the second cell; or
filling the second cell based on the content of the first cell.
